(19) United States
(12) Patent Application Publication
(10) Pub. No.: US 2009/0099319 A1
(43) Pub. Date: Apr. 16, 2009

(54) METHOD FOR SOLUBILISING HYDROPHOBIC ACTIVE SUBSTANCES IN AN AQUEOUS MEDIUM

(75) Inventors: Jean-Francois Stumbe, Strasbourg (FR); Bernd Bruchmann, Freinsheim (DE); Holger Turk, Mannheim (DE); Rainer Haag, Berlin (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, LUDWIGSHAFE (DE)

(21) Appl. No.: 12/297,654

(22) PCT Filed: Apr. 16, 2007
(86) PCT No.: PCT/EP2007/053675

§ 371 Date: Oct. 20, 2008

(30) Foreign Application Priority Data
Apr. 28, 2006 (EP) 06113255.1

(51) Int. Cl. C08G 63/12

(52) U.S. Cl. 525/440.01; 528/272

(57) ABSTRACT

The present invention relates to a process for solubilizing hydrophobic active substances in an aqueous medium, which comprises using as assistant at least one hyperbranched polymer obtainable by
(a) preparing at least one hyperbranched polyester
   (a1) by polycondensing at least one dicarboxylic acid or one or more derivatives thereof with one or more at least trifunctional alcohols, or
   (a2) by polycondensing at least one tricarboxylic acid or higher polycarboxylic acid or one or more derivatives thereof with one or more diols, or
   (a3) by polycondensing at least one dicarboxylic acid or at least one derivative thereof with a mixture of at least one diol and at least one at least tetrafunctional alcohol, or
   (a4) by polycondensing at least one diol with a mixture of at least one dicarboxylic acid or at least one derivative thereof and at least one tricarboxylic or tetracarboxylic acid or at least one derivative thereof,
(b) reacting the polyester with at least one isocyanate or chlorocarbonic ester which carries at least one polyalkylene oxide unit attached via a carbonate group, urea group or urethane group,
   or one hyperbranched polyester (a).

The present invention relates to a process for solubilizing hydrophobic active substances in an aqueous medium, which comprises using as assistant at least one hyperbranched polymer obtainable by
(a) preparing at least one hyperbranched polyester
   (a1) by polycondensing at least one dicarboxylic acid or one or more derivatives thereof with one or more at least trifunctional alcohols, or
   (a2) by polycondensing at least one tricarboxylic acid or higher polycarboxylic acid or one or more derivatives thereof with one or more diols, or
   (a3) by polycondensing at least one dicarboxylic acid or at least one derivative thereof with a mixture of at least one diol and at least one at least trifunctional alcohol, or
   (a4) by polycondensing at least one diol with a mixture of at least one dicarboxylic acid or at least one derivative thereof and at least one tricarboxylic or tetracarboxylic acid or at least one derivative thereof,
(b) if appropriate, reacting the polyester with at least one isocyanate or chlorocarbonic ester which carries at least one polyalkylene oxide unit attached via a carbonate group, urea group or urethane group,
   or one hyperbranched polyester (a).

The present invention further relates to hyperbranched polymers obtainable by
(a) preparing at least one hyperbranched polyester
   (a1) by polycondensing at least one dicarboxylic acid or one or more derivatives thereof with one or more at least trifunctional alcohols, or
   (a2) by polycondensing at least one tricarboxylic acid or higher polycarboxylic acid or one or more derivatives thereof with one or more diols, or
   (a3) by polycondensing at least one dicarboxylic acid or at least one derivative thereof with a mixture of at least one diol and at least one at least trifunctional alcohol, or
   (a4) by polycondensing at least one diol with a mixture of at least one dicarboxylic acid or at least one derivative thereof and at least one tricarboxylic or tetracarboxylic acid or at least one derivative thereof,
(b) reacting the polyester with at least one isocyanate or chlorocarbonic ester which carries at least one polyalkylene oxide unit attached via a carbonate group, urea group or urethane group.

The present invention further relates to complexes comprising at least one hyperbranched polymer of the invention and at least one hydrophobic active substance, and also to a process for producing complexes of the invention. The present invention additionally relates to a process for preparing hyperbranched polymers of the invention.

In many cases it is necessary to solubilize hydrophobic substances, such as hydrophobic active substances, for example, in water without chemically modifying the relevant active substance per se. For this purpose it is possible for example to prepare an emulsion in which the relevant active substance is in the oil phase. With many active pharmaceutical substances or crop protection agents, however, particularly with those which are to be transported with a body fluid or in a plant's sap, an approach of this kind is not possible. Under the action of high shearing forces it is possible for emulsions to break. Moreover, sterilizing while retaining the emulsion is in many cases not a possibility.

It is known from DE-A 33 16 510, for example, that hydrophobic active pharmaceutical substances can be dissolved in solvent mixtures of ethanol and water and propylene glycol or polyethylene glycol and can be processed to give, for example, formulations that can be administered parenterally. Solvent mixtures of this kind generally comprise 15% to 30% by weight of ethanol. In many cases, however, a concern is to avoid such large amounts of alcohol in the treatment of ill persons.

Also known is the solubilization of active substances based on 1,4-dihydropyridines with phospholipids, especially liposome phospholipids, in water; see, for example, EP 0 560 138 A. Liposome phospholipids, however, are subject to the same degradation mechanisms as endogenous cell membrane lipids. Liposomal transport systems prepared in such a way, therefore, are of only limited shelf life, depending on pH and ionic strength of the medium. Particularly as a result of the shearing forces which occur in the course of the intravenous administration of the active substances, liposomal transport systems can easily be destroyed.

In many cases, furthermore, excessive concentrations of the nanotransporter and of the active substance are observed in the liver and/or the spleen; unwanted transport from the blood vessels into the surrounding tissue is observed; and a slow release of the encapsulated active substance after just a short time is observed, owing to the dynamic structure of the lipid double layer. The difficulty of sterilization is a further reason why liposomes are not suited to all applications in active-substance transport.

DE 10 2004 039 875 discloses multishell systems with polar and apolar shells that are suitable as what is called a nanotransport system. Proposed as the core of the multishell systems disclosed are dendritic polymers which are functionalized to an extent of less than 100%, where possible 50% (see paragraph [0030]). A disadvantage of the multishell systems disclosed in DE 10 2004 039 875, however, is that, especially when they are first dried and are then to be redispersed in water, they exhibit a marked tendency to form gel.

It was an object, therefore, to provide an improved process for solubilizing hydrophobic active substances that does not have the disadvantages known from the prior art. A further object was to provide transport systems which avoid the disadvantages known from the prior art.

It is to this effect that the process defined at the outset has been found.

By solubilization is meant that active substance which is hydrophobic in an aqueous medium, in other words insoluble or sparingly soluble per se, can be molecularly dispersely distributed. This can be done, for example, by complexing or enveloping the relevant hydrophobic active substance.

By an aqueous medium is meant in the sense of the present invention, for example, the following: water, solvent mixtures of water and at least one organic solvent such as methanol, ethanol, ethylene glycol, propylene glycol, polyethylene glycol, isopropanol, 1,4-dioxane or N,N-dimethylformamide, for example, aqueous sugar solutions such as aqueous glucose solution, for example, aqueous salt solutions such as aqueous sodium chloride or aqueous potassium chloride solutions, for example, aqueous buffer solutions such as phosphate buffer, for example, or, especially, plant saps or human or animal body fluids containing water, such as blood, urine, and splenic fluid, for example.

Preferably an aqueous medium means pure (distilled) water, aqueous sodium chloride solution, especially physiological saline solution, or solvent mixtures of water of at least one of the abovementioned organic solvents, the fraction of organic solvent not exceeding 10% by weight of the aqueous medium in question.

Active substances in the sense of the present invention can also be termed effect substances and are substances of the kind which have, for example, an action as a crop protection agent, such as an insecticide, herbicide or fungicide, for example, or which have an action as a fluorescent agent or a pharmaceutical action, as a cardiovascular agent or cytostatic, for example. Pigments are not active substances in the sense of the present invention.

Examples of suitable cardiovascular agents are, for example, those of the formula I.

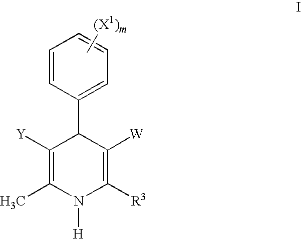

In this formula the variables and radicals are defined as follows:
Y is NO₂, CN or COOR¹, where
R¹ is C₁-C₄ alkyl, such as methyl, ethyl, n-propyl, isopropyl, n-butyl, isobutyl, sec-butyl, tert-butyl, unsubstituted or substituted one or more times by C₁-C₃ alkoxy, such as methoxy, ethoxy, n-propoxy, isopropoxy; examples of substituted radicals R¹ are for example methoxymethyl, ethoxymethyl, 2-methoxyethyl.
W is CO—NH—C₃-C₇ cycloalkyl or COOR², where
R² is selected from C₁-C₁₀ alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; with particular preference C₁-C₄ alkyl such as methyl, ethyl, n-propyl, isopropyl, n-butyl, isobutyl, sec-butyl, and tert-butyl, especially methyl unsubstituted or substituted one or more times by C₁-C₃ alkoxy, trifluoromethyl, N-methyl-N-benzylamino or CH₂—C₆H₅. Examples of substituted radicals R² are for example methoxymethyl, ethoxymethyl, 2-methoxyethyl, 2,2,2-trifluoroethyl.
R³ is selected from CN, ω-hydroxyalkyl, preferably ω-hydroxy-C₁-C₄-alkyl, especially hydroxymethyl and 2-hydroxyethyl, or C₁-C₄ alkyl such as methyl, ethyl, n-propyl, isopropyl, n-butyl, isobutyl, sec-butyl and tert-butyl.
X¹ is in each case alike or different and selected from NO₂, halogen, especially fluorine, chlorine or bromine, C₁-C₄ alkyl such as methyl, ethyl, n-propyl, isopropyl, n-butyl, isobutyl, sec-butyl, and tert-butyl, C₁-C₄ alkoxy, such as methoxy, ethoxy, n-propoxy, isopropoxy, n-butoxy, isobutoxy, sec-butoxy, tert-butoxy; benzoyl, acetyl, O—CO—CH₃, trifluoromethyl or 2-(4-methylbenzyloxy).
m is selected from whole numbers in the range from zero to two, preferably one or two.

Examples of particularly suitable active pharmaceutical substances include nifedipine, nimodipine (1,4-dihydro-2,6-dimethyl-4-(3′-nitrophenyl)pyridine 3-β-methoxyethyl ester 5-isopropyl ester, known from DE 28 15 278), nisoldipine, nitrendipine, felodipine, and amlodipine.

By hydrophobic in connection with active substances is meant that the solubility in distilled water at 20° C. is preferably below 0.1 g/l, more preferably below 0.01 g/l.

Examples of suitable cytostatics are doxorubicin and paclitaxel.

Examples of suitable active fungicidal substances which can be solubilized in accordance with the process of the invention comprise the following:

acylalanines such as benalaxyl, metalaxyl, ofurace, oxadixyl;
amine derivatives such as aldimorph, dodine, dodemorph, fenpropimorph, fenpropidin, guazatine, iminoctadine, spiroxamin, tridemorph;
anilinopyrimidines such as pyrimethanil, mepanipyrim or cyrodinyl;
antibiotics such as cycloheximide, griseofulvin, kasugamycin, natamycin, polyoxin, and streptomycin;
azoles such as bitertanol, bromoconazole, cyproconazole, difenoconazole, dinitroconazole, epoxiconazole, fenbuconazole, fluquiconazole, flusilazole, flutriafol, hexaconazole, imazalil, ipconazole, metconazole, myclobutanil, penconazole, propiconazole, prochloraz, prothioconazole, tebuconazole, tetraconazole, triadimefon, triadimenol, triflumizole, triticonazole;
2-methoxybenzophenones, as described by the general formula I in EP-A 897904, e.g., metrafenone;
dicarboximides such as iprodione, myclozolin, procymidone, vinclozolin; dithiocarbamates such as ferbam, nabam, maneb, mancozeb, metam, metiram, propineb, polycarbamate, thiram, ziram, zineb;
heterocyclic compounds such as anilazine, benomyl, boscalid, carbendazim, carboxin, oxycarboxin, cyazofamid, dazomet, dithianon, famoxadon, fenamidon, fenarimol, fuberidazole, flutolanil, furametpyr, isoprothiolane, mepronil, nuarimol, picobezamid, probenazole, proquinazid, pyrifenox, pyroquilon, quinoxyfen, silthiofam; thiabendazole, thifluzamid, thiophanate-methyl, tiadinil, tricyclazole, triforine;
nitrophenyl derivatives such as binapacryl, dinocap, dinobuton, nitrophthal-isopropyl; phenylpyrroles such as fenpiclonil and also fludioxonil;
unclassified fungicides such as acibenzolar-S-methyl, benthiavalicarb, carpropamid, chlorothalonil, cyflufenamid, cymoxanil, diclomezin, diclocymet, diethofencarb, edifenphos, ethaboxam, fenhexamid, fentin acetate, fenoxanil, ferimzone, fluazinam, fosetyl, fosetyl aluminum, iprovalicarb, hexachlorobenzene, metrafenon, pencycuron, propamocarb, phthalide, toloclofos-methyl, quintozene, zoxamide;
strobilurins as described by the general formula I in WO 03/075663, examples being azoxystrobin, dimoxystrobin, fluoxastrobin, kresoxim-methyl, metominostrobin, orysastrobin, picoxystrobin, pyraclostrobin, and trifloxystrobin;
sulfenic acid derivatives such as captafol, captan, dichlofluanid, folpet, tolylfluanid; cinnamamides and analogs such as dimethomorph, flumetover, flumorph;
6-aryl-[1,2,4]triazolo[1,5-a]pyrimidines as described by the general formula I in each for example of WO 98/46608, WO 99,41255 or WO 03/004465;
amide fungicides such as cyclofenamid and also (Z)-N-[α-(cyclopropylmethoxyimino)-2,3-difluoro-6-(difluoromethoxy)benzyl]-2-phenylacetamide.

Examples of herbicides which can be formulated as an aqueous active-substance composition of the invention comprise the following:

1,3,4-thiadiazoles such as buthidazole and cyprazole;
amides such as allidochlor, benzoylpropethyl, bromobutide, chlorthiamid, dimepiperate, dimethenamid, diphenamid, etobenzanid, flamprop-methyl, fosamin, isoxaben, metazachlor, monalide, naptalam, pronamide, propanil;
aminophosphoric acids such as bilanafos, buminafos, glufosinate ammonium, glyphosate, sulfosate;
aminotriazoles such as amitrole, anilides such as anilofos, mefenacet;
aryloxyalkanoic acid such as 2,4-D, 2,4-DB, clomeprop, dichlorprop, dichlorprop-P, dichlorprop-P, fenoprop, fluoroxypyr, MCPA, MCPB, mecoprop, mecoprop-P, napropamide, napropanilide, triclopyr;
benzoic acids such as chloramben, dicamba;
benzothiadiazinones such as bentazone;
bleachers such as clomazone, diflufenican, fluorochloridone, flupoxam, fluridone, pyrazolate, sulcotrione;
carbamates such as carbetamid, chlorbufam, chlorpropham, desmedipham, phenmedipham, vernolate;
dichloropropionic acids such as dalapon;
dihydrobenzofurans such as ethofumesate;
dihydrofuran-3-one such as flurtamone;
dinitroanilines such as benefin, butralin, dinitramin, ethalfluralin, fluchloralin, isopropalin, nitraiin, oryzalin, pendimethalin, prodiamine, profluralin, trifluralin, dinitrophenols such as bromofenoxim, dinoseb, dinoseb acetate, dinoterb, DNOC, minoterb acetate;
diphenyl ethers such as acifluorfen sodium, aclonifen, bifenox, chlornitrofen, difenoxuron, ethoxyfen, fluorodifen, fluoroglycofen ethyl, fomesafen, furyloxyfen, lactofen, nitrofen, nitrofluorfen, oxyfluorfen;
dipyridyls such as cyperquat, difenzoquat methyl sulfate, diquat, paraquat dichloride;
imidazoles such as isocarbamid;
imidazolinones such as imazamethapyr, imazapyr, imazaquin, imazethabenz methyl, imazethapyr, imazapic, imazamox;
oxadiazoles such as methazole, oxadiargyl, oxadiazon;
oxiranes such as tridiphane;
phenols such as bromoxynil, ioxynil;
phenoxyphenoxypropionic esters such as clodinafop, cyhalofop butyl, diclofop methyl, fenoxaprop ethyl, fenoxaprop p-ethyl, fenthiaprop ethyl, fluazifop butyl, fluazifop p-butyl, haloxyfop ethoxyethyl, haloxyfop methyl, haloxyfop p-methyl, isoxapyrifop, propaquizafop, quizalofop ethyl, quizalofop p-ethyl, quizalofop tefuryl;
phenylacetic acids such as chlorfenac;
phenylpropionic acids such as chlorophenprop methyl;
ppi (ppi=preplant incorporated) active substances such as benzofenap, flumiclorac pentyl, flumioxazin, flumipropyn, flupropacil, pyrazoxyfen, sulfentrazone, thidiazimin;
pyrazoles such as nipyraclofen;
pyridazines such as chloridazon, maleic hydrazide, norflurazon, pyridate;
pyridinecarboxylic acids such as clopyralid, dithiopyr, picloram, thiazopyr;
pyrimidyl ethers such as pyrithiobac acid, pyrithiobac sodium, KIH-2023, KIH-6127;
quinolinic acids such as quinclorac, quinmerac;
sulfonamides such as flumetsulam, metosulam;
triazolecarboxamides such as triazofenamid;
uracils such as bromacil, lenacil, terbacil;
and additionally benazolin, benfuresate, bensulide, benzofluor, bentazone, butamifos, cafenstrole, chlorthal dimethyl, cinmethylin, dichlobenil, endothall, fluorbentranil, mefluidide, perfluidone, piperophos, topramezone, and prohexandione-calcium;
sulfonylureas such as amidosulfuron, azimsulfuron, bensulfuron methyl, chlorimuron ethyl, chlorsulfuron, cinosulfuron, cyclosulfamuron, ethametsulfuron methyl, flazasulfuron, halosulfuron methyl, imazosulfuron, metsulfuron methyl, nicosulfuron, primisulfuron, prosulfuron, pyrazosulfuron ethyl, rimsulfuron, sulfometuron methyl, thifensulfuron methyl, triasulfuron, tribenuron methyl, triflusulfuron methyl, tritosulfuron;
active crop protection ingredients of the cyclohexenone type such as alloxydim, clethodim, cloproxydim, cycloxydim, sethoxydim, and tralkoxydim.

Very particularly preferred active herbicidal substances of the cyclohexenone type are:

tepraloxydim (cf. AGROW, No. 243, 11.3.95, page 21, caloxydim), and
2-(1-[2-{4-chlorophenoxy}propyloxyimino]butyl)-3-hydroxy-5-(2H-tetrahydrothiopyran-3-yl)-2-cyclohexen-1-one
and of the sulfonylurea type: N-(((4-methoxy-6-[trifluoromethyl]-1,3,5-triazin-2-yl)-amino)carbonyl)-2-(trifluoromethyl)benzenesulfonamide.

Examples of suitable insecticides comprise the following:

organophosphates such as acephate, azinphos-methyl, chlorpyrifos, chlorfenvinphos, diazinon, dichlorvos, dimethylvinphos, dioxabenzofos, dicrotophos, dimethoate, disulfoton, ethion, EPN, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, primiphos-ethyl, pyraclofos, pyridaphenthion, sulprophos, triazophos, trichlorfon; tetrachlorvinphos, vamidothion
carbamates such as alanycarb, benfuracarb, bendiocarb, carbaryl, carbofuran, carbosulfan, fenoxycarb, furathiocarb, indoxacarb, methiocarb, methomyl, oxamyl, pirimicarb, propoxur, thiodicarb, triazamate;
pyrethroids such as bifenthrin, cyfluthrin, cycloprothrin, cypermethrin, deltamethrin, esfenvalerate, ethofenprox, fenpropathrin, fenvalerate, cyhalothrin, lambda-cyhalothrin, permethrin, silafluofen, tau-fluvalinate, tefluthrin, tralomethrin, alpha-cypermethrin, zeta-cypermethrin, permethrin;
arthropodal growth regulators: a) chitin synthesis inhibitors, e.g., benzoylureas such as chlorfluazuron, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists such as halofenozide, methoxyfenozide, tebufenozide; c) juvenoids such as pyriproxyfen, methoprene, fenoxycarb; d) lipid biosynthesis inhibitors such as spirodiclofen;
neonicotinoids such as flonicamid, clothianidin, dinotefuran, imidacloprid, thiamethoxam, nitenpyram, nithiazin, acetamiprid, thiacloprid;
further, unclassified insecticides such as abamectin, acequinocyl, acetamiprid, amitraz, azadirachtin, bensultap, bifenazate, cartap, chlorfenapyr, chlordimeform, cyromazine, diafenthiuron, dinetofuran, diofenolan, emamectin, endosulfan, ethiprole, fenazaquin, fipronil, formetanate, formetanate hydrochloride, gamma-HCH, hydramethylnon, imidacloprid, indoxacarb, isoprocarb, metolcarb, pyridaben, pymetrozine, spinosad, tebufenpyrad, thiamethoxam, thiocyclam, XMC, and xylylcarb.

N-Phenylsemicarbazones, as described by the general formula I in EP-A 462 456, particularly compounds of the general formula II

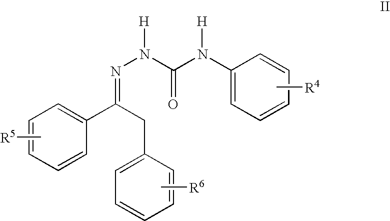

in which R⁵ and R⁶ independently of one another are hydrogen, halogen, CN, C₁-C₄ alkyl, C₁-C₄ alkoxy, C₁-C₄ haloalkyl or C₁-C₄ haloalkoxy and R⁴ is C₁-C₄ alkoxy, C₁-C₄ haloalkyl or C₁-C₄ haloalkoxy, e.g., compound IV, in which R⁵ is 3-CF₃ and R⁶ is 4-CN and R⁴ is 4-OCF₃.

Examples of growth regulators which can be used are chlormequat chloride, mepiquat chloride, prohexadione-calcium or those from the group of the gibberellins. These include, for example, the gibberellins GA₁, GA₃, GA₄, GA₅ and GA₇ etc., and the corresponding exo-16,17-dihydrogibberellins, and also the derivatives thereof, examples being esters with C₁-C₄ carboxylic acids. Preference in accordance with the invention is given to exo-16,17-dihydro-GA₅ 13-acetate.

Preferred fungicides are, in particular, strobilurins, azoles, and 6-aryltriazolo[1,5-a]pyrimidines, as described by the general formula I in WO 98/46608, WO 99/41255 or WO 03/004465, for example, especially active substances of the general formula III,

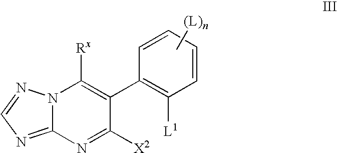

in which:
R^{x} is a group NR⁷R⁸, or linear or branched C₁-C₈ alkyl substituted if appropriate by halogen, OH, C₁-C₄ alkoxy, phenyl or C₃-C₆ cycloalkyl, or is C₂-C₆ alkenyl, C₃-C₆ cycloalkyl, C₃-C₆ cycloalkenyl, phenyl or naphthyl, it being possible for the four last-mentioned radicals to have 1, 2, 3 or 4 substituents selected from halogen, OH, C₁-C₄ alkyl, C₁-C₄ haloalkoxy, C₁-C₄ alkoxy, and C₁-C₄ haloalkyl;
   R⁷ and R⁸ independently of one another are hydrogen, C₁-C₈ alkyl, C₁-C₈ haloalkyl, C₃-C₁₀ cycloalkyl, C₃-C₆ halocycloalkyl, C₂-C₈ alkenyl, C₄-C₁₀ alkadienyl, C₂-C₈ haloalkenyl, C₃-C₆ cycloalkenyl, C₂-C₈ halocycloalkenyl, C₂-C₈ alkynyl, C₂-C₈ haloalkynyl or C₃-C₆ cycloalkynyl, or
   R⁷ and R⁸, together with the nitrogen atom to which they are attached, are five- to eight-membered heterocyclyl, which is attached via N and may comprise one, two or three further heteroatoms from the group O, N, and S, as ring members, and/or may carry one or more substituents from the group of halogen, C₁-C₆ alkyl, C₁-C₆ haloalkyl, C₂-C₆ alkenyl, C₂-C₆ haloalkenyl, C₁-C₆ alkoxy, C₁-C₆ haloalkoxy, C₃-C₆ alkenyloxy, C₃-C₆ haloalkenyloxy, (exo)-C₁-C₆ alkylene, and oxy-C₁-C₃ alkyleneoxy;
L is selected from halogen, cyano, C₁-C₆ alkyl, C₁-C₄ haloalkyl, C₁-C₆ alkoxy, C₁-C₄ haloalkoxy, and C₁-C₆ alkoxycarbonyl;
L¹ is halogen, C₁-C₆ alkyl or C₁-C₆ haloalkyl, and especially fluorine or chlorine;
X² is halogen, C₁-C₄ alkyl, cyano, C₁-C₄ alkoxy or C₁-C₄ haloalkyl, and preferably is halogen or methyl, and in particular is chlorine.

Examples of compounds of the formula III are
5-chloro-7-(4-methylpiperidin-1-yl)-6-(2,4,6-trifluorophenyl)-[1,2,4]triazolo[1,5-a]pyrimidine, 5-chloro-7-(4-methylpiperazin-1-yl)-6-(2,4,6-trifluorophenyl)-[1,2,4]triazolo[1,5-a]pyrimidine, 5-chloro-7-(morpholin-1-yl)-6-(2,4,6-trifluorophenyl)-[1,2,4]triazolo[1,5-a]pyrimidine,
5-chloro-7-(piperidin-1-yl)-6-(2,4,6-trifluorophenyl)-[1,2,4]triazolo[1,5-a]pyrimidine,
5-chloro-7-(morpholin-1-yl)-6-(2,4,6-trifluorophenyl)-[1,2,4]triazolo[1,5-a]pyrimidine,
5-chloro-7-(isopropylamino)-6-(2,4,6-trifluorophenyl)-[1,2,4]triazolo[1,5-a]pyrimidine,
5-chloro-7-(cyclopentylamino)-6-(2,4,6-trifluorophenyl)-[1,2,4]triazolo[1,5-a]pyrimidine,
5-chloro-7-(2,2,2-trifluoroethylamino)-6-(2,4,6-trifluorophenyl)-[1,2,4]triazolo[1,5-a]-pyrimidine,
5-chloro-7-(1,1,1-trifluoropropan-2-ylamino)-6-(2,4,6-trifluorophenyl)-[1,2,4]triazolo[1,5-a]pyrimidine,
5-chloro-7-(3,3-dimethylbutan-2-ylamino)-6-(2,4,6-trifluorophenyl)-[1,2,4]triazolo[1,5-a]-pyrimidine,
5-chloro-7-(cyclohexylmethyl)-6-(2,4,6-trifluorophenyl)-[1,2,4]triazolo[1,5-a]pyrimidine,
5-chloro-7-(cyclohexyl)-6-(2,4,6-trifluorophenyl)-[1,2,4]triazolo[1,5-a]pyrimidine,
5-chloro-7-(2-methylbutan-3-yl)-6-(2,4,6-trifluorophenyl)-[1,2,4]triazolo[1,5-a]pyrimidine,
5-chloro-7-(3-methylpropan-1-yl)-6-(2,4,6-trifluorophenyl)-[1,2,4]triazolo[1,5-a]pyrimidine, 5-chloro-7-(4-methylcyclohexan-1-yl)-6-(2,4,6-trifluorophenyl)-[1,2,4]triazolo[1,5-a]pyrimidine,
5-chloro-7-(hexan-3-yl)-6-(2,4,6-trifluorophenyl)-[1,2,4]triazolo[1,5-a]pyrimidine,
5-chloro-7-(2-methylbutan-1-yl)-6-(2,4,6-trifluorophenyl)-[1,2,4]triazolo[1,5-a]pyrimidine,
5-chloro-7-(3-methylbutan-1-yl)-6-(2,4,6-trifluorophenyl)-[1,2,4]triazolo[1,5-a]pyrimidine,
5-chloro-7-(1-methylpropan-1-yl)-6-(2,4,6-trifluorophenyl)-[1,2,4]triazolo[1,5-a]pyrimidine, 5-methyl-7-(4-methylpiperidin-1-yl)-6-(2,4,6-trifluorophenyl)-[1,2,4]triazolo[1,5-a]pyrimidine,
5-methyl-7-(4-methylpiperazin-1-yl)-6-(2,4,6-trifluorophenyl)-[1,2,4]triazolo[1,5-a]-pyrimidine,
5-methyl-7-(morpholin-1-yl)-6-(2,4,6-trifluorophenyl)-[1,2,4]triazolo[1,5-a]pyrimidine,
5-methyl-7-(piperidin-1-yl)-6-(2,4,6-trifluorophenyl)-[1,2,4]triazolo[1,5-a]pyrimidine,
5-methyl-7-(morpholin-1-yl)-6-(2,4,6-trifluorophenyl)-[1,2,4]triazolo[1,5-a]pyrimidine,
5-methyl-7-(isopropylamino)-6-(2,4,6-trifluorophenyl)-[1,2,4]triazolo[1,5-a]pyrimidine,
5-methyl-7-(cyclopentylamino)-6-(2,4,6-trifluorophenyl)-[1,2,4]triazolo[1,5-a]pyrimidine,
5-methyl-7-(2,2,2-trifluoroethylamino)-6-(2,4,6-trifluorophenyl)-[1,2,4]triazolo[1,5-a]-pyrimidine,
5-methyl-7-(1,1,1-trifluoropropan-2-ylamino)-6-(2,4,6-trifluorophenyl)-[1,2,4]triazolo[1,5-a]pyrimidine,
5-methyl-7-(3,3-dimethylbutan-2-ylamino)-6-(2,4,6-trifluorophenyl)-[1,2,4]triazolo[1,5-a]-pyrimidine,
5-methyl-7-(cyclohexylmethyl)-6-(2,4,6-trifluorophenyl)-[1,2,4]triazolo[1,5-a]pyrimidine,
5-methyl-7-(cyclohexyl)-6-(2,4,6-trifluorophenyl)-[1,2,4]triazolo[1,5-a]pyrimidine,
5-methyl-7-(2-methylbutan-3-yl)-6-(2,4,6-trifluorophenyl)-[1,2,4]triazolo[1,5-a]pyrimidine, 5-methyl-7-(3-methylpropan-1-yl)-6-(2,4,6-trifluorophenyl)-[1,2,4]triazolo[1,5-a]pyrimidine, 5-methyl-7-(4-methylcyclohexan-1-yl)-6-(2,4,6-trifluorophenyl)-[1,2,4]triazolo[1,5-a]pyrimidine,
5-methyl-7-(hexan-3-yl)-6-(2,4,6-trifluorophenyl)-[1,2,4]triazolo[1,5-a]pyrimidine,
5-methyl-7-(2-methylbutan-1-yl)-6-(2,4,6-trifluorophenyl)-[1,2,4]triazolo[1,5-a]pyrimidine, 5-methyl-7-(3-methylbutan-1-yl)-6-(2,4,6-trifluorophenyl)-[1,2,4]triazolo[1,5-a]pyrimidine and 5-methyl-7-(1-methylpropan-1-yl)-6-(2,4,6-trifluorophenyl)-[1,2,4]triazolo[1,5-a]pyrimidine.

Suitable insecticides are, in particular
arylpyrroles such as chlorfenapyr, from pyrethroids such as bifenthrin, cyfluthrin, cycloprothrin, cypermethrin, deltamethrin, esfenvalerate, ethofenprox, fenpropathrin, fenvalerate, cyhalothrin, lambda-cyhalothrin, permethrin, silafluofen, tau-fluvalinate, tefluthrin, tralomethrin, α-cypermethrin, zeta-cypermethrin, and permethrin,
neonicotinoids, and
semicarbazones of the formula II.

Suitable fluorescent agents are, for example, pyrene, uranin, rhodamine, fluorescein, coumarin, allophycocyanine, naphthalene, anthracene.

In one embodiment of the present invention the process of the invention can be used to solubilize in the range from 0.01% to 1% by weight of hydrophobic active substance in aqueous medium, preferably at least 0.1% by weight, based on total aqueous formulation prepared in accordance with the invention.

The process of the invention is carried out using at least one hyperbranched polymer (c) obtainable by
(a) preparing at least one hyperbranched polyester, also referred to below as hyperbranched polyester (a),
   (a1) by polycondensing at least one dicarboxylic acid or one or more derivatives thereof with one or more at least trifunctional alcohols, or
   (a2) by polycondensing at least one tricarboxylic acid or higher polycarboxylic acid or one or more derivatives thereof with one or more diols,
   (a3) by polycondensing at least one dicarboxylic acid or at least one derivative thereof with a mixture of at least one diol and at least one at least trifunctional alcohol, or
   (a4) by polycondensing at least one diol with a mixture of at least one dicarboxylic acid or at least one derivative thereof and at least one tricarboxylic or tetracarboxylic acid or at least one derivative thereof,
(b) preferably reacting the polyester with at least one isocyanate or chlorocarbonic ester which carries at least one polyalkylene oxide unit attached via a carbonate group, urea group or urethane group. Isocyanates and chlorocarbonic esters of this kind are also referred to below for short as isocyanate (b) and chlorocarbonic ester (b), respectively,
   or one hyperbranched polyester (a).

Hyperbranched polyesters (a) and hence also the hyperbranched polymers prepared from them are molecularly and structurally nonuniform. By virtue of their molecular nonuniformity they differ from dendrimers, for example, and are preparable with considerably less complexity and expense. An example of the molecular construction of a hyperbranched polymer on the basis of an AB₂ molecule is found for example in WO 04/20503 on page 2. For the construction (distribution of the branchings, etc.) the approach is analogous for the polyesters used, for example, in the present specification, which are based on an A₂+Bₓ strategy (with x≧3)—see, for example, J.-F. Stumbé et al., Macromol. Rapid Commun. 2004, 25, 921.

In one embodiment of the present invention there is a branching in 20 to 70 mol %, preferably 30 to 60 mol %, of each A₂Bₓ monomer unit in hyperbranched polyester (a).

In one embodiment of the present invention the polydispersity of hyperbranched polyester (a) is 1.2 to 50, preferably 1.4 to 40, more preferably 1.5 to 30, and very preferably up to 20.

The solubility of hyperbranched polyesters (a) is typically very good: that is, solutions with a clear appearance containing up to 50% by weight, in certain cases up to 80% or even up to 99% by weight, of hyperbranched polyester (a) can be prepared in tetrahydrofuran (THF), n-butyl acetate, ethanol, and numerous other solvents, without gel particles being detectable with the naked eye.

Hyperbranched polyesters (a) are carboxy- and hydroxyl-terminated and are preferably predominantly hydroxyl-terminated.

In one embodiment of the present invention hyperbranched polyester (a) is a hyperbranched polyester having an acid number in the range from 1 to 100 mg KOH/g, preferably 20 to 45 mg KOH/g, as determinable in accordance for example with DIN 53402.

Examples of dicarboxylic acids which can be reacted in accordance with version (a1) include for example oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, and cis- and trans-cyclopentane-1,3-dicarboxylic acid,

it being possible for the abovementioned dicarboxylic acids to be unsubstituted or substituted by one or more radicals selected from
C₁-C₁₀ alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl or n-decyl, for example,
C₃-C₁₂ cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl, for example; preferably cyclopentyl, cyclohexyl, and cycloheptyl;
alkylene groups such as methylene or ethylidene, or
C₆-C₁₄ aryl groups such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, for example, preferably phenyl, 1-naphthyl, and 2-naphthyl, more preferably phenyl.

Exemplary representatives that may be mentioned of substituted dicarboxylic acids include the following: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

The dicarboxylic acids that can be reacted in accordance with version (a1) further include ethylenically unsaturated acids such as, for example, maleic acid and fumaric acid and also aromatic dicarboxylic acids such as, for example, phthalic acid, isophthalic acid or terephthalic acid.

In addition it is possible to use mixtures of two or more of the aforementioned dicarboxylic acids.

Abovementioned dicarboxylic acids can be used either as they are or in the form of derivatives.

By derivatives are meant preferably
the relevant anhydrides in monomeric or else polymeric form,
monoalkyl or dialkyl esters, preferably monomethyl or dimethyl esters or the corresponding monoethyl or diethyl esters, but also the monoalkyl and dialkyl esters derived from higher alcohols such as, for example, n-propanol, isopropanol, n-butanol, isobutanol, tert-butanol, n-pentanol or n-hexanol,
acid halides, especially acid chlorides,
additionally, monovinyl and divinyl esters, and also
mixed esters, preferably methyl ethyl esters.

In the context of the present invention it is also possible to use a mixture of a dicarboxylic acid and at least one of its derivatives. Equally it is possible in the context of the present invention to use a mixture of two or more different derivatives of one or more dicarboxylic acids.

Particular preference is given to using succinic acid, glutaric acid, adipic acid, phthalic acid, isophthalic acid, terephthalic acid, hexahydrophthalic acid, hexahydrophthalic anhydride, cyclohexene-3,4-dicarboxylic acid or the monomethyl or dimethyl esters thereof. Very particular preference is given to using adipic acid.

As at least trifunctional alcohols it is possible for example to react the following: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, 1,1,1-trimethylolbutane (trimethylolbutane), 1,1,1-trimethylolpropane (trimethylolpropane) or ditrimethylolpropane, trimethylolethane, pentaerythritol or dipentaerythritol; sugar alcohols such as, for example, mesoerythritol, threitolol, sorbitol, mannitol or mixtures of the above at least trifunctional alcohols. Preference is given to using glycerol, trimethylolpropane, trimethylolethane, and pentaerythritol.

In one embodiment of the present invention at least trifunctional alcohols are singly or multiply, such as 1- to 100-tuply alkoxylated, preferably 3- to 100-tuply ethoxylated glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane, ditrimethylolpropane, trimethylolethane, pentaerythritol or dipentaerythritol, having molecular weights Mₙ in particular in the range from 300 to 5000 g/mol.

Tricarboxylic or polycarboxylic acids which can be reacted in accordance with version (a2) are for example 1, 2,4-benzenetricarboxylic acid, 1,3,5-benzenetricarboxylic acid, 1,2,4,5-benzenetetracarboxylic acid, and mellitic acid.

In the reaction of the invention tricarboxylic acids or polycarboxylic acids can be used either as they are or else in the form of derivatives.

By derivatives are meant preferably
the relevant anhydrides in monomeric or else polymeric form,
monoalkyl, dialkyl or trialkyl esters, preferably monomethyl, dimethyl or trimethyl esters or the corresponding monoethyl, diethyl or triethyl esters, but also the monoesters, diesters and triesters derived from higher alcohols such as, for example, n-propanol, isopropanol, n-butanol, isobutanol, tert-butanol, n-pentanol or n-hexanol,
acid halides, especially acid chlorides,
monovinyl, divinyl or trivinyl esters
and mixed methyl ethyl esters.

In the context of the present invention it is also possible to use a mixture of a tricarboxylic or polycarboxylic acid and at least one of its derivatives. It is equally possible in the context of the present invention to use a mixture of two or more different derivatives of one or more tricarboxylic or polycarboxylic acids.

Diols used for version (a2) of the present invention include for example ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, neopentyl glycol (2,2-dimethylpropane-1,3-diol), hexane-1,2-diol, hexane-1,3-diol, hexane-1,4-diol, hexane-1,5-diol, hexane-1,6-diol, hexane-2,5-diol, heptane-1,2-diol 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, 2-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H, or mixtures of two or more representatives of the foregoing compounds, n being an integer and n≧4. In this case it is possible also for one or else both hydroxyl groups in the aforementioned diols to be substituted by SH groups. Preference is given to ethylene glycol, propane-1,2-diol and also diethylene glycol, triethylene glycol, dipropylene glycol, and tripropylene glycol.

In one embodiment of the present invention OH component and carboxylic acid component are used in step (a1) or (a2) or (a3) or (a4) in a ratio such that the molar ratio of OH groups to COOH groups, free or derivatized, is in the range from 2:1 to 1:2, preferably 1:1.8 to 1.8:1, more preferably 1:1.5 to 1.5:1.

Dicarboxylic acids and derivatives thereof suitable for implementing version (a3) have been specified above. Diols and at least trifunctional alcohols suitable for implementing version (a3) have likewise been specified above.

Diols suitable for implementing version (a4) have been specified above. Dicarboxylic acids and their derivatives, and also tricarboxylic acids and tetracarboxylic acids and their derivatives, suitable for implementing version (a4) have likewise been specified above.

In one embodiment of the present invention version (a3) is implemented by using diol and at least trifunctional alcohol in a molar ratio in the range from 5:1 to 1:100, preferably 4:1 to 1:10, and more preferably 3:1 to 1:10.

In one embodiment of the present invention version (a4) is implemented by using dicarboxylic acid and/or derivative of dicarboxylic acid and tricarboxylic acid or tetracarboxylic acid and/or derivative of tricarboxylic acid or tetracarboxylic acid in a molar ratio in the range from 5:1 to 1:100, preferably 4:1 to 1:10, and more preferably 3:1 to 1:10.

The at least trifunctional alcohols reacted in accordance with version (a1) may have hydroxyl groups each of equal reactivity.

The at least trifunctional alcohols reacted in accordance with version (a1) may alternatively contain hydroxyl groups having at least two chemically different reactivities.

The difference in reactivity of the functional groups such as hydroxyl groups, for example, may derive either from chemical circumstances (e.g., primary/secondary/tertiary OH group) or from steric circumstances. Preference is also given here to compounds that are reactive with acid groups and whose OH groups are initially of equal reactivity, but in which it is nevertheless possible, by reaction of at least one acid group, to induce a drop in reactivity, caused by steric or electronic influences, in the remaining OH groups. This is the case for example when using trimethylolpropane or pentaerythritol.

The triol may for example be a triol which has primary and secondary hydroxyl groups; a preferred example is glycerol.

When implementing the reaction in accordance with version (a1) it is preferred to operate in the absence of diols.

When implementing the reaction in accordance with version (a2) it is preferred to operate in the absence of mono- or dicarboxylic acids.

In one specific embodiment of the present invention it is possible during the preparation, preferably toward the end of the preparation, of hyperbranched polyester (a) to add one or more stoppers, selected from monocarboxylic acids such as, for example, fatty acids or their anhydrides or methyl or ethyl esters, monoalcohols, carboxylic acids with a further functional group (or two or more such groups), or corresponding derivatives.

Examples of monofunctional monocarboxylic acids are acetic acid, propionic acid, trimethylacetic acid, heptanoic acid, pelargonic acid, lauric acid, myristic acid, palmitic acid, montanic acid, isostearic acid, stearic acid, isononanoic acid, and 2-ethylhexanoic acid.

Examples of carboxylic acids having one or more further functional groups are mono- or polyethylenically unsaturated fatty acids such as, for example, oleic acid, linoleic acid, linseed oil, soybean oil, dehydrogenated castor oil, sunflower oil, and linolenic acid.

Further examples of carboxylic acids having one or more functional groups are meth(acrylic) acid or derivatives of methacrylic acid, particularly 2-hydroxyethyl (meth)acrylate, 3-hydroxypropyl (meth)acrylate, and 4-hydroxybutyl (meth)acrylate.

Examples of suitable alcohols include glycerol monolaurate, glycerol monostearate, ethylene glycol monomethyl ether, polyethylene glycol monomethyl ether, benzyl alcohol, 1-dodecanol, 1-tetradecanol, 1-hexadecanol, and mono- or poly-ethylenically unsaturated fatty alcohols.

After the preparation of hyperbranched polyester (a) it is possible to enhance in purity hyperbranched polyester (a). Preferably, however, no purity enhancement is carried out.

Preferably hyperbranched polyester (a) is reacted with at least one chlorocarbonic ester (b), more preferably at least one isocyanate (b), with particular preference in a one-pot reaction.

The preparation of chlorocarbonic esters (b) and isocyanates (b) is known per se. The procedure adopted for preparing chlorocarbonic esters (b) is preferably such that a diol, one of the abovementioned diols by way of example, is reacted with two equivalents of phosgene, diphosgene or, preferably, triphosgene to form a bis-chlorocarbonic ester, which is then reacted with a polyalkylene glycol preferably capped with a C₁-C₄ alkyl group.

To prepare isocyanates (b) the preferred procedure is to react a diisocyanate, preferably one of the diisocyanates specified below, with one equivalent of polyalkylene glycol preferably capped with a C₁-C₄ alkyl group, or to react it with a corresponding polyalkylene glycol amine.

Particularly suitable capped polyalkene glycols are polypropylene glycol capped with a C₁-C₄ alkyl group and polyethylene glycol capped with a C₁-C₄ alkyl group, and having, for example, a molecular weight Mₙ in the range from 150 to 5000 g/mol, preferably 350 to 2000 g/mol, more preferably 350 to 1000 g/mol.

Suitable diisocyanates are aromatic, cycloaliphatic, and, in particular, aliphatic diisocyanates. The following may be mentioned by way of example: tolylene 2,4-diisocyanate, diphenylmethane 4,4′-diisocyanate, naphthylene 1,7-diisocyanate, isophorone diisocyanate, trimethylene diisocyanate, tetramethylene diisocyanate, hexamethylene diisocyanate, dodecamethylene diisocyanate, cyclohexane 1,4-diisocyanate, hexahydrotolylene 2,4-diisocyanate, hexahydrotolylene 2,6-diisocyanate, and dicyclohexylmethane 4,4′-diisocyanate.

The preparation of chlorocarbonic ester (b) is accomplished especially well in the presence of base, pyridine or triethylamine or trimethylamine for example.

The preparation of isocyanate (b) can be carried out in the presence of catalysts such as tin compounds, for example, preferably di-n-butyltin diacetate or di-n-butyltin dilaurate, or in the absence of catalyst.

The preparation of isocyanates (b) can be carried out for example in accordance with or in analogy to H. Petersen et al., Macromolecules 2002, 35, 6867 ff.

An example of a possible procedure for reacting hyperbranched polyester (a) with chlorocarbonic ester (b) is to introduce hyperbranched polyester (a) to start with and to add one or more bases, pyridine or triethylamine for example, and chlorocarbonic ester (b).

An example of a possible procedure for reacting hyperbranched polyester (a) with isocyanate (b) is to introduce hyperbranched polyester (a) to start with and to add isocyanate (b) and, if appropriate, one or more catalysts, examples being one or more organotin compounds, especially one of the abovementioned tin compounds.

The reaction of hyperbranched polyester (a) with chlorocarbonic ester (b) or isocyanate (b) can be carried out solventlessly or, preferably, in one or more organic solvents. Examples of suitable solvents are N,N-dimethylformamide (DMF), tetrahydrofuran (THF), 1,4-dioxane, ethylene glycol dimethyl ether, dimethylsulfoxide, chloroform, dichloromethane, acetonitrile, dimethylacetamide, N-methylpyrrolidone, xylene, toluene, and acetone.

In one embodiment of the present invention the reaction of hyperbranched polyester (a) with chlorocarbonic ester (b) or isocyanate (b) is conducted at room temperature or preferably at elevated temperature. With particular preference the reaction of hyperbranched polyester (a) with chlorocarbonic ester (b) or isocyanate (b) is conducted at temperatures in the range from 40 to 120° C., especially when not using any catalyst.

In one embodiment of the present invention the proportions of hyperbranched polyester (a) and chlorocarbonic ester (b) or isocyanate (b), respectively, are selected such that at least 90 mol % of the functional groups, preferably at least 90 mol % of the hydroxyl groups, and more preferably 90 to 99 mol % of the functional groups of hyperbranched polyester (a) have undergone reaction with chlorocarbonic ester (b) or isocyanate (b), respectively.

In one embodiment of the present invention hyperbranched polyester (a) is selected from hyperbranched polyesters having a molecular weight Mₙ in the range from 500 to 50 000 g/mol, preferably up to 20 000 g/mol, as determinable by means for example of gel permeation chromatography.

In one embodiment of the present invention hyperbranched polyester (a) is contacted with one or more hydrophobic active substances and aqueous medium, by means of mixing for example. In one preferred embodiment of the present invention hyperbranched polymer (c) of the invention is contacted with one or more hydrophobic active substances and aqueous medium, by means of mixing for example. Mixing can be implemented for example by stirring with conventional stirrers or with high-speed stirrers. Other suitable methods are the use of ultrasound or intensive shaking.

In one embodiment of the present invention hyperbranched polyester (a) and hydrophobic active substance are employed in a mass ratio in the range from 1:1-1000:1, preferably 1:1 to 100:1.

In one embodiment of the present invention hyperbranched polymer (c) and hydrophobic active substance are employed in a mass ratio in the range from 1:1-1000:1, preferably 1:1 to 100:1.

In one embodiment hyperbranched polyester (a) or preferably hyperbranched polymer (c) are stirred together with aqueous medium and subsequently with one or more active substances.

Mixing may take place at temperatures in the range from 0° C. to 100° C. and, if the use of increased pressure is desired, at temperatures up to 150° C., even. It is preferred to operate under atmospheric pressure and at temperatures in the range from 20 to 70° C.

In one embodiment of the present invention, when mixing is at an end, hydrophobic active substance which has not been solubilized is separated off, by filtration or centrifugation, for example.

The present invention further provides hyperbranched polymers obtainable by
(a) preparing at least one hyperbranched polyester obtainable
   (a1) by polycondensing at least one dicarboxylic acid or one or more derivatives thereof with one or more at least trifunctional alcohols, or
   (a2) by polycondensing at least one tricarboxylic acid or higher polycarboxylic acid or one or more derivatives thereof with one or more diols, or
   (a3) by polycondensing at least one dicarboxylic acid or at least one derivative thereof with a mixture of at least one diol and at least one at least trifunctional alcohol, or
   (a4) by polycondensing at least one diol with a mixture of at least one dicarboxylic acid or at least one derivative thereof and at least one tricarboxylic or tetracarboxylic acid or at least one derivative thereof,
(b) reacting the polyester with at least one isocyanate or chlorocarbonic ester which carries at least one polyalkylene oxide unit attached via a carbonate group, urea group or urethane group.

The hyperbranched polymers of the invention are also referred to for short below as hyperbranched polymers (c) or as hyperbranched polymers (c) of the invention. With polymers (c) of the invention the process of the invention for solubilizing can be performed to particularly good effect.

In one embodiment of the present invention, hyperbranched polymers (c) of the invention are polymers having an acid number in the range from 0.1 to 50 mg KOH/g, preferably 20 to 45 mg KOH/g, determinable in accordance for example with DIN 53402.

In one embodiment of the present invention hyperbranched polymer (c) of the invention is a polymer for which hyperbranched polyester (a) is reacted

(b1) with at least one reaction product of at least one diisocyanate with a polyalkylene glycol capped with a C₁-C₄ alkyl group.

In one embodiment of the present invention at least 90 mol % of the functional groups, preferably at least 90 mol % of the hydroxyl groups, and preferably 90 to 99 mol % of the functional groups of hyperbranched polyester (a) have undergone reaction with isocyanate (b) or a chlorocarbonic ester (b) which carries at least one polyalkylene oxide unit attached via a carbonate group, urea group or urethane group.

The preparation of hyperbranched polymers (c) of the invention can be carried out for example as described above.

The present invention further provides a process for preparing the hyperbranched polymers (c) of the invention. In particular the present invention provides a process for preparing hyperbranched polymers (c) of the invention by reacting
(a) at least one hyperbranched polyester obtainable
   (a1) by polycondensing at least one dicarboxylic acid or one or more derivatives thereof with one or more at least trifunctional alcohols, or
   (a2) by polycondensing at least one tricarboxylic acid or higher polycarboxylic acid or one or more derivatives thereof with one or more diols, or
   (a3) by polycondensing at least one dicarboxylic acid or at least one derivative thereof with a mixture of at least one diol and at least one at least trifunctional alcohol, or
   (a4) by polycondensing at least one diol with a mixture of at least one dicarboxylic acid or at least one derivative thereof and at least one tricarboxylic or tetracarboxylic acid or at least one derivative thereof,
(b) with at least one isocyanate or chlorocarbonic ester which carries at least one polyalkylene oxide unit attached via a carbonate group, urea group or urethane group.

To prepare the hyperbranched polymers (c) of the invention it is possible for example to adopt the procedure described above.

In one embodiment of the present invention the preparation of hyperbranched polyester (a) is carried out in the presence of a solvent. Suitable solvents are, for example, hydrocarbons such as paraffins or aromatics. Particularly suitable paraffins are n-heptane and cyclohexane. Particularly suitable aromatics are toluene, ortho-xylene, meta-xylene, para-xylene, xylene isomer mixture, ethylbenzene, chlorobenzene, and ortho- and meta-dichlorobenzene. The following are additionally and very particularly suitable as solvents in the absence of acidic catalysts: chloroform, methylene chloride, and N,N-dimethylformamide, ethers such as dioxane or tetrahydrofuran, for example, and ketones such as methyl ethyl ketone and methyl isobutyl ketone, for example.

The amount of added solvent is in accordance with the invention at least 0.1% by weight, based on the mass of the starting materials employed and intended for reaction; preferably said amount is at least 1% by weight, and with particular preference at least 10% by weight. It is also possible to employ excesses of solvent, relative to the mass of starting materials employed and intended for reaction, examples being an excess of 1.01 to 10 times. Solvent amounts of more than 100 times, relative to the mass of starting materials employed and intended for reaction, are not advantageous, since with significantly lower concentrations of the reactants the reaction rate subsides significantly, leading to uneconomic long reaction times.

In order to implement the process of the invention it is possible to operate in the presence of a water-removing additive added at the beginning of the reaction. Suitable examples include molecular sieves, especially 4 Å molecular sieve, MgSO₄, and Na₂SO₄. It is also possible during the reaction to add further water remover, or to replace water remover by fresh water remover. It is also possible to remove alcohol and/or water formed during the reaction by distillation and to use, for example, a water separator.

In another embodiment of the present invention the preparation of hyperbranched polyester (a) is carried out without the use of solvent.

In one embodiment of the present invention the preparation of hyperbranched polyester (a) is carried out in the absence of acidic catalysts.

One embodiment of the present invention operates in the presence of an acidic organic, inorganic or organometallic catalyst or of mixtures of two or more acidic organic, inorganic or organometallic catalysts.

Acidic inorganic catalysts in the sense of the present invention are for example sulfuric acid, phosphoric acid, phosphonic acid, hypophosphorous acid, aluminum sulfate hydrate, alum, acidic silica gel (pH≦6, in particular ≦5), and acidic alumina. It is additionally possible to make use for example of aluminum compounds of the general formula Al(OR⁹)₃ and titanates of the general formula Ti(OR⁹)₄ as acidic inorganic catalysts, it being possible for the radicals R⁹ to be in each case identical or different, and these radicals being selected independently of one another from

C₁-C₁₀ alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl or n-decyl, for example,
C₃-C₁₂ cycloalkyl radicals, such as cyclopropyl, cyclobutyl, cyclopentyl, cyclohexyl, cycloheptyl, cyclooctyl, cyclononyl, cyclodecyl, cycloundecyl, and cyclododecyl, for example; preferably cyclopentyl, cyclohexyl, and cycloheptyl.

The radicals R⁹ in Al(OR⁹)₃ and Ti(OR⁹)₄, respectively, are preferably each identical and selected from isopropyl or 2-ethylhexyl.

Preferred acidic organometallic catalysts are selected for example from dialkyltin oxides (R⁹)₂SnO, R⁹ being as defined above. One particularly preferred representative of acidic organometallic catalysts is di-n-butyltin oxide, which is available commercially as oxo-tin.

Preferred acidic organic catalysts are acidic organic compounds having for example phosphate groups, sulfonic acid groups, sulfate groups or phosphonic acid groups. Particularly preferred are sulfonic acids such as para-toluenesulfonic acid, for example. Acidic ion exchangers can also be used as acidic organic catalysts, examples being polystyrene resins containing sulfonic acid groups and crosslinked with approximately 2 mol % of divinylbenzene.

Combinations of two or more of the aforementioned catalysts can also be employed. Additionally it is possible to use organic or organometallic or else inorganic catalysts which are present in the form of discrete molecules, in an immobilized form.

If it is desired to use acidic organic, inorganic or organometallic catalysts, then the amount employed in accordance with the invention is 0.1 to 10% by weight, preferably 0.2 to 2% by weight, of catalyst, based on the sum of the respective reactants in version (a1) or (a2) or (a3) or (a4), respectively.

In another embodiment of the present invention the preparation of hyperbranched polyester (c) of the invention is carried out in the presence of one or more enzymes. It is preferred to use lipases and esterases. Highly suitable lipases and esterases are Candida cylindracea, Candida lipolytica, Candida rugosa, Candida antarctica, Candida utilis, Chromobacterium viscosum, Geotrichum viscosum, Geotrichum candidum, Mucor javanicus, Mucor mihei, pig pancreas, Pseudomonas spp., Pseudomonas fluorescens, Pseudomonas cepacia, Rhizopus arrhizus, Rhizopus delemar, Rhizopus niveus, Rhizopus oryzae, Aspergillus niger, Penicillium roquefortii, Penicillium camembertii or esterase from Bacillus spp. and Bacillus thermoglucosidasius. Particular preference is given to Candida antarctica lipase B. The listed enzymes are available commercially, from Novozymes Biotech Inc., Denmark, for example.

It is preferred to employ enzyme in immobilized form, on silica gel or Lewatit® or polymethyl methacrylate (Novozyme 435®) for example. Methods of immobilizing enzymes are known per se, as for example from Kurt Faber, “Biotransformations in organic chemistry”, 3rd edition 1997, Springer Verlag, section 3.2 “Immobilization” pages 345-356. Immobilized enzymes are available commercially, from Novozymes Biotech Inc., Denmark, for example.

The amount of enzyme used is 1 to 20% by weight, in particular 10-15% by weight, based on the mass of the entirety of starting materials that are employed.

In one embodiment of the present invention the preparation of hyperbranched polyester (a) is conducted at a temperature in the range from 100 to 220° C., preferably 120 to 200° C. This embodiment is preferred when operating without catalyst or with nonenzymatic catalyst.

In another embodiment of the present invention the preparation of hyperbranched polyester (a) is carried out at a temperature in the range from 40 to 120° C., preferably 50 to 100° C., and more preferably 65 to 90° C. This embodiment is preferred when operating without catalyst or with one or more enzymes as catalyst.

The preparation of hyperbranched polyester (a) can be carried out under atmospheric pressure. It is preferred, however, to prepare hyperbranched polyester (a) under reduced pressure, at for example in the range from 1 mbar to 500 mbar, preferably 5 mbar to 400 mbar.

Where it is desired to use ethylenically unsaturated monocarboxylic or dicarboxylic acids in the preparation of hyperbranched polyester (a), it may be sensible to work at temperatures below 120° C., preferably below 100° C. Additionally it may be sensible to use one or more free-radical scavengers (inhibitors). Examples of suitable free-radical scavengers are phenolic compounds such as MEHQ (hydroquinone monomethyl ether), 3,5-di-tert-butyl-4-hydroxytoluene (BHT), aromatic or aliphatic phosphites, phenothiazine, nitroxyl compounds such as TEMPO, OH-TEMPO (2,2,6,6-tetramethylpiperidinyl-1-oxy), methoxy-TEMPO, and alkoxamine initiators such as, for example, N-tert-butyl N-(1-diethylphosphono-2,2-dimethylpropyl) nitroxide.

After the end of chemical reaction for preparing hyperbranched polymer (a) and (c) of the invention it is possible in many cases to forgo purity enhancement.

In another embodiment of the present invention purity enhancement is carried out after the end of chemical reaction for preparing hyperbranched polymer (c) of the invention. Purity enhancement of this kind may comprise—for example, when chlorocarbonic ester (b) has been used—the removal of salts that have formed and/or, if appropriate, of catalyst that has been used, or of decomposition products of catalyst that has been used, if appropriate. In addition it may be rational to separate off by-products formed, for example, during the preparation of chlorocarbonic ester (b) or isocyanate (b).

It is possible to operate in accordance with methods known per se, such as by chromatography, reprecipitation, filtration, particle size-dependent separation methods such as ultrafiltration, for example, or by dialysis, for example.

The present invention further provides complexes comprising at least one hyperbranched polymer (c) of the invention and at least one hydrophobic active substance. By complexes in this context are meant not only complexes in the sense of the theories of complexes, but also inclusion compounds or other aggregates of hydrophobic active substance and hyperbranched polymer (c) of the invention, without any intention to give preference to one particular theory.

Complexes of the invention may comprise, for example, one or more molecules of hydrophobic active substance and one or more molecules of hyperbranched polymer (c) of the invention, and hence need not comprise exactly one molecule of hydrophobic active substance and exactly one molecule of hyperbranched polymer (c) of the invention. In addition it is also possible for complexes of the invention to comprise water as an inclusion.

The present invention further provides a process for preparing complexes of the invention. A procedure which can be used to prepare complexes of the invention is to mix at least one hydrophobic active substance and at least one hyperbranched polymer (c) of the invention or at least one hyperbranched polyester (a), using for example one of the methods specified above, with one another, preferably in the presence of water.

The present invention further provides complexes comprising at least one hyperbranched polyester (a) and at least one hydrophobic active substance. By complexes in this context are meant not only complexes in the sense of the theories of complexes, but also inclusion compounds or other aggregates of hydrophobic active substance and hyperbranched polyester (a) without any intention to give preference to one particular theory.

Complexes of the invention may comprise, for example, one or more molecules of hydrophobic active substance and one or more molecules of hyperbranched polyester (a), and hence need not comprise exactly one molecule of hydrophobic active substance and exactly one molecule of hyperbranched polyester (a). In addition it is also possible for complexes of the invention to comprise water as an inclusion.

The present invention additionally provides aqueous formulations comprising at least one complex of the invention, in concentrations for example of 0.01-400 g/l, with particular preference of 0.015-100 g/l.

Complexes of the invention and therefore aqueous formulations of the invention can be used for example, depending on the hydrophobic active substance employed, as crop protection compositions or as or for producing medicaments.

The invention is illustrated by working examples.

### I. Preparation of Hyperbranched Polyesters (a)

### I.1 Preparation of Hyperbranched Polyester (a.1)

70.85 g (0.6 mol) of succinic acid and 335 g (0.5 mol) of ethoxylated 1,1,1-trimethylolpropane (approximately 12 mol of ethylene oxide/mole of trimethylolpropane) were charged to a 500 ml four-necked flask equipped with stirrer, internal thermometer, gas inlet tube, reflux condenser (water separator), and vacuum connection with cold trap. 0.2 ml of sulfuric acid (0.02 M) was added and the mixture was heated to an internal temperature of 150° C. A reduced pressure of 200 mbar was applied in order to separate off water formed during the reaction. After 2 hours of stirring at 150° C., the pressure was reduced to 60 mbar over the course of 2 hours. The reaction mixture was subsequently stirred at 150° C. and 10 mbar for 5 hours. 88 g (0.13 mol) of ethoxylated 1,1,1-trimethylolpropane (approximately 12 mol of ethylene oxide/mole of trimethylolpropane) were then added to the reaction mixture, which was subsequently stirred for an hour at the stated temperature and at the stated pressure. Thereafter it was cooled to room temperature. This gave 439 g of hyperbranched polyester (a.1) as a water-soluble, clear, viscous liquid (3100 mPa·s, determined at 50° C.) having an acid number of 21 mg KOH/g. The analytical data are summarized in Table 1.

### I.2 Preparation of Hyperbranched Polyester (a.2)

70.85 g (0.6 mol) of succinic acid and 155 g (0.5 mol) of ethoxylated glycerol (approximately 5 mol of ethylene oxide/mole of glycerol) were charged to a 500-ml four-necked flask equipped with stirrer, internal thermometer, gas inlet tube, reflux condenser (water separator), and vacuum connection with cold trap. 0.2 ml of sulfuric acid (0.02 M) was added and the mixture was heated to an internal temperature of 120° C. A reduced pressure of 150 mbar was applied in order to separate off water formed during the reaction. After 5 hours of stirring at 120° C., the pressure was reduced to 100 mbar. The reaction mixture was subsequently stirred at 120° C. and 100 mbar for 3 hours. A further 78.6 g (0.25 mol) of ethoxylated glycerol (approximately 5 mol of ethylene oxide/mole of glycerol) were then added to the reaction mixture, which was subsequently stirred for 1.5 hours more at 120° C. and at 100 mbar. Thereafter it was cooled to room temperature. This gave 279 g of hyperbranched polyester (a.2) as a water-soluble, clear, viscous liquid (6000 mPa·s at 50° C.) having an acid number of 40 mg KOH/g. The analytical data are summarized in Table 1.

### I.3 Preparation of Hyperbranched Polyester (a.3)

87.66 g (0.6 mol) of adipic acid and 335 g (0.5 mol) of ethoxylated 1,1,1-trimethylolpropane (approximately 12 mol of ethylene oxide/mole of trimethylolpropane) were charged to a 1 l four-necked flask equipped with stirrer, internal thermometer, gas inlet tube, reflux condenser (water separator), and vacuum connection with cold trap. 0.2 ml of sulfuric acid (0.02 M) was added and the mixture was heated to an internal temperature of 140° C. A reduced pressure of 250 mbar was applied in order to separate off water formed during the reaction. After 5 hours of stirring at 140° C., the pressure was reduced to 90 mbar. The reaction mixture was subsequently stirred at 140° C. and 80 mbar for 2.5 hours. Then the pressure was reduced to 15 mbar and the reaction mixture was stirred for an additional 4 hours at 140° C. and 15 mbar. A further 252 g (0.0.38 mol) of ethoxylated trimethylolpropane (approximately 12 mol of ethylene oxide/mole of trimethylolpropane) were then added to the reaction mixture, which was subsequently stirred for 2 hours at 140° C. and at 80 mbar. Thereafter it was cooled to room temperature. This gave 596 g of hyperbranched polyester (a.3) as a water-soluble, clear, viscous liquid (800 mPa·s, at 50° C.) having an acid number of 20 mg KOH/g. The analytical data are summarized in Table 1.

### I.4 Preparation of Hyperbranched Polyester (a.4)

87.66 g (0.6 mol) of adipic acid and 155 g (0.5 mol) of ethoxylated glycerol (approximately 5 mol of ethylene oxide/mole of glycerol) were charged to a 1 l four-necked flask equipped with stirrer, internal thermometer, gas inlet tube, reflux condenser (water separator), and vacuum connection with cold trap. 0.2 ml of sulfuric acid (0.02 M) was added and the mixture was heated to an internal temperature of 120° C. A reduced pressure of 400 mbar was applied in order to separate off water formed during the reaction. After 3.5 hours, the pressure was reduced to 270 mbar. The reaction mixture was subsequently held at 120° C. and 270 mbar for 4 hours. A further 79 g (0.25 mol) of ethoxylated glycerol (approximately 5 mol of ethylene oxide/mole of glycerol) were then added to the reaction mixture, which was subsequently stirred for 3.5 hours at 120° C. and at 270 mbar. Thereafter it was cooled to room temperature. This gave 205 g of hyperbranched polyester (a.4) as a water-soluble, clear, viscous liquid (3200 mPa·s at 50° C.) having an acid number of 33 mg KOH/g. The analytical data are summarized in Table 1.

### I.5 Preparation of Hyperbranched Polyester (a.5)

212.6 g (1.8 mol) of succinic acid and 138.1 g (1.5 mol) of glycerol were charged to a 500 ml four-necked flask equipped with stirrer, internal thermometer, gas inlet tube, reflux condenser (water separator), and vacuum connection with cold trap. 0.2 ml of sulfuric acid (0.02 M) was added and the mixture was heated to an internal temperature of 125° C. A reduced pressure of 400 mbar was applied in order to separate off water formed during the reaction. The reaction mixture was subsequently stirred at 125° C. and 400 mbar for 5 hours. A further 111 g (1.2 mol) of glycerol were then added to the reaction mixture, which was subsequently stirred for 2.5 hours more at 125° C. and at 400 mbar. Thereafter it was cooled to room temperature. This gave 392 g of hyperbranched polyester (a.5) as a water-soluble, clear, viscous liquid (1200 mPa·s at 75° C.) having an acid number of 44 mg KOH/g. The analytical data are summarized in Table 1.

### I.6 Preparation of Hyperbranched Polyester (a.6)

2016 g (13.8 mol) of adipic acid and 1059 g (11.5 mol) of glycerol were charged to a 4 l four-necked flask equipped with stirrer, internal thermometer, gas inlet tube, reflux condenser (water separator), and vacuum connection with cold trap. 3.04 g of di-n-butyltin oxide, available commercially as Fascat® 4201, were added and the mixture was heated to an internal temperature of 150° C. A reduced pressure of 100 mbar was applied in order to separate off water formed during the reaction. The reaction mixture was subsequently held at the stated temperature and pressure for 4 hours. 400 g (4.35 mol) of glycerol were then added to the reaction mixture, which was subsequently stirred for 15 hours more at 150° C. and at 100 mbar. Thereafter it was cooled to room temperature. This gave 3205 g of hyperbranched polyester (a.6) as a water-insoluble, clear, viscous liquid (5200 mPa·s at 75° C.) having an acid number of 30 mg KOH/g. The analytical data are summarized in Table 1.

TABLE 1
Analytical properties of the hyperbranched polyesters (a.1) to (a.6)

| | Acid number | OH number | | |
|---|---|---|---|---|
| No. | [mg KOH/g] | [mg KOH/g] | Mₙ [g/mol] | M_{w} [g/mol] |
| (a.1) | 21 | 103 | 1575 | 14 200 |
| (a.2) | 40 | 250 | 980 | 4130 |
| (a.3) | 20 | 142 | 1130 | 7940 |
| (a.4) | 33 | 231 | 1660 | 16 240 |
| (a.5) | 44 | 676 | 520 | 950 |
| (a.6) | 30 | 103 | 2110 | 11 230 |

II. Reaction of Hyperbranched Polyester (a) with Isocyanate (b)

### II.1 Preparation of Isocyanate (b.1)

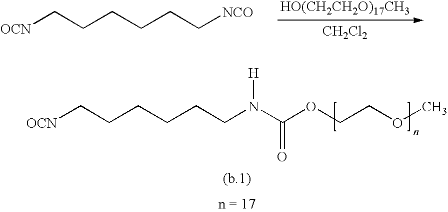

A 250 ml three-necked flask fitted with a reflux condenser and a dropping funnel was charged with 9.71 ml (10.10 g; 60.0 mmol) of HMDI and this initial charge was dissolved under an argon atmosphere in 20 ml of anhydrous dichloromethane. The solution thus obtainable was heated to reflux. With vigorous stirring a solution of 50 g (66.7 mmol) of polyethylene glycol monomethyl ether (Mₙ=750 g/mol) in 50 ml of anhydrous dichloromethane was added over the course of 8 hours by means of the dropping funnel. After the end of the addition the reaction mixture was heated under reflux for a further 4 hours.

The batch was worked up by cooling to room temperature and removing the dichloromethane solvent under reduced pressure. No further purity enhancement was carried out. This gave 60.1 g of a mixture of (PEG monomethyl ether)-N-hexamethylenecarbamate isocyanate (86% according to ¹H-NMR; about 47.4 g; 51.6 mmol) and di-(PEG monomethyl ether)-N,N-hexamethylenedicarbamate (14% according to ¹H-NMR) in the form of a colorless solid which was stored at −30° C.

¹H-NMR (CDCl₃, 500 MHz, impurities at 1.16, 2.45 and 5.25 ppm): δ (ppm)=1.26; 1.33; 1.43; 1.55 [m, OCN—CH₂—(CH₂)₄—CH₂—NH—C(O)O-PEG-OCH₃], 3.08 [t, OCN—CH₂—(CH₂)₄—CH₂—NH—C(O)O-PEG-OCH₃], 3.23 [m, OCN—CH₂—(CH₂)₄—CH₂—NH—C(O)O-PEG-OCH₃], 3.31 [s, OCN—CH₂—(CH₂)₄—CH₂—NH—C(O)O-PEG-OCH₃], 3.40-3.75 [m, OCN—CH₂—(CH₂)₄—CH₂—NH—C(O)O—CH₂CH₂O-PEG-OCH₃], 4.13 [m, OCN—CH₂—(CH₂)₄—CH₂—NH—C(O)O—CH₂CH₂O-PEG-OCH₃], 4.90 [s, OCN—CH₂—(CH₂)₄—CH₂—NH—C(O)O-PEG-OCH₃]; ¹³C-NMR (CDCl₃, 125.8 MHz): δ (ppm)=25.9; 26.9; 26.2; 26.3; 29.8; 31.1 [OCN—CH₂—(CH₂)₄—CH₂—NH—C(O)O-PEG-OCH₃], 40.8 [OCN—CH₂—(CH₂)₄—CH₂—NH—C(O)O-PEG-OCH₃], 42.8 [OCN—CH₂—(CH₂)₄—CH₂—NH—C(O)O-PEG-OCH₃], 59.0 [OCN—CH₂—(CH₂)₄—CH₂—NH—C(O)O-PEG-OCH₃], 63.7 [OCN—CH₂—(CH₂)₄—CH₂—NH—C(O)O—CH₂CH₂O-PEG-OCH₃], 69.6 [OCN—CH₂—(CH₂)₄—CH₂—NH—C(O)O—CH₂CH₂O-PEG-OCH₃], 70.5 [OCN—CH₂—(CH₂)₄—CH₂—NH—C(O)O-PEG-OCH₃], 71.9 [OCN—CH₂—(CH₂)₄—CH₂—NH—C(O)O-PEG-OCH₂CH₂—OCH₃], 122.0 [OCN—CH₂—(CH₂)₄—CH₂—NH—C(O)O-PEG-OCH₃], 156.4 [OCN—CH₂—(CH₂)₄—CH₂—NH—C(O)O-PEG-OCH₃].

IR (KBr): wavenumber [cm⁻¹]=3310 [N—H], 2880 [C—H], 2275 [N═C═O], 1690 [RHNC(═O)OR], 1540 [RHNC(═O)OR], 1115 [C—O—C].

II.2 Reaction of Isocyanate (b.1) with Hyperbranched Polyester (a.6)

A 250 ml three-necked flask fitted with a reflux condenser and a dropping funnel was charged with 2.50 g of polyester (a.6) and this initial charge was dissolved under argon in 20 ml of anhydrous DMF. The batch was heated to 60° C. With vigorous stirring a solution of 9.62 g (10.48 mmol) of isocyanate (b.1) from II.1 (12.20 g of the mixture were used) in 50 ml of anhydrous DMF was added over the course of 6 hours by means of the dropping funnel. After the end of the addition the reaction mixture was heated under reflux for 6 hours.

The batch was worked up by cooling to room temperature and removing the DMF under reduced pressure. The residue was taken up in water and dialyzed in water (tube MWCO 4000, 24 hours; the solvent was changed twice) in order to separate off not only PEG that has not been coupled but also the by-product of the preparation of the starting material. This gave 11.96 g (>95%, >95% conversion according to ¹H-NMR) of the hyperbranched polymer (c.1) of the invention, in the form of a water-soluble, colorless solid.

¹H-NMR (CD₃OD, 500 MHz, impurity at 1.21 ppm): δ (ppm)=1.34; 1.49 [m, PES-O—C(O)NH—CH₂—(CH₂)₄—CH₂—NH—C(O)O-PEG-OCH₃], 1.65 [m, ROOC—CH₂CH₂CH₂CH₂—COOR], 2.30 [m, ROOC—(CH₂)₃CH₂—COOH], 2.38 [m, ROOC—CH₂(CH₂)₂CH₂—COOR], 3.08 [m, PES-O—C(O)NH—CH₂—(CH₂)₄—CH₂—NH—C(O)O-PEG-OCH₃], 3.35 [s, R-PEG-OCH₃], 3.40-3.80 [m, PES-O—C(O)NH—(CH₂)₆—NH—C(O)O—CH₂CH₂O-PEG-OCH₃], 3.90-4.40 [m, PES-O—C(O)NH—(CH₂)₆—NH—C(O)O—CH₂CH₂O-PEG-OCH₃], 5.08, 5.28 [m, RO—CH(CH₂OR)₂ (PES)]; ¹³C-NMR (CD₃OD, 125.8 MHz): δ (ppm)=25.3 [ROOC—CH₂CH₂CH₂CH₂—COOR/H], 27.5, 30.8 [PES-O—C(O)NH—CH₂(CH₂)₄CH₂—NH—C(O)O-PEG-OCH₃], 34.4 [ROOC—CH₂CH₂CH₂CH₂—COOR/H], 41.6; 41.8 [PES-O—C(O)NH—CH₂(CH₂)₄CH₂—NH—C(O)O-PEG-OCH₃], 59.1 [R-PEG-OCH₃], 61.5; 63.4; 63.7; 64.9; 66.1; 68.4; 68.7; 70.6; 71.3 [PES-Q-C(O)NH—(CH₂)₆—NH—C(O)O—CH₂CH₂O-PEG-OCH₃], 71.5 [PES-O—C(O)NH—(CH₂)₆—NH—C(O)O-PEG-OCH₃], 72.9 [PES-O—C(O)NH—(CH₂)₆—NH—C(O)O-PEG-OCH₂CH₂—OCH₃], 158.6, 158.8 [PES-O—C(O)NH—(CH₂)₆—NH—C(O)O-PEG-OCH₃], 174.0; 174.4; 174.7 [ROOC—CH₂CH₂CH₂CH₂—COOR/H].

IR (KBr): wavenumber [cm⁻¹]=3510 [O—H], 3310 [N—H], 2880 [C—H], 1725 [RC(═O)OR], 1695 [RHNC(═O)OR], 1540 [RHNC(═O)OR], 1110 [C—O—C].

### III. Solubilization of Pyrene and of Nimodipine

### General Instructions:

1 ml of an aqueous solution (1% by weight) of the respective hyperbranched polymer of the invention was admixed with the respective solid active substance (nimodipine or pyrene) in excess, and the resulting suspension was mixed using a magnetic stirrer in a closed vessel at room temperature for 18 hours. The excess solid was separated off by subsequently centrifuging the solutions twice at 15 000 rpm (20 minutes in each case), producing in all instances a clear, saturated solution of active substance. Subsequently the amount of the guest molecules complexed was determined by means of UV-VIS spectra, the reference sample used in each case being the respective aqueous polymer solution with the same concentration and the same preparation (likewise centrifuged). This was done using, for nimodipine, the strong absorption at 355 nm and, for pyrene, its strong absorption at 334 nm. For the case of particularly good solubilization by an appropriate auxiliary, however, for both guest molecules there was a bathochromic shift in the absorption maxima to about 365 nm and to about 340 nm respectively, so that the actual absorption maximum in each case was evaluated here. Using calibration plots of the active substances in methanol or ethanol it was then possible to calculate the solubilized amounts of nimodipine and pyrene, respectively, under the assumption that the extinction coefficients of the active substances in methanol/ethanol and in water are equal to a first approximation. For all of the solubilization experiments evaluated in this way, the measurement error was ±5%. The calibration plots of nimodipine in methanol and of pyrene in ethanol themselves were produced by recording UV-VIS spectra on solutions with different, known concentrations of the active substances.

Where it was the case, with the UV-VIS spectra of the saturated active-substance solutions, that the absorption measured lay outside the linear region of the calibration plot, the solution in question was diluted and immediately then a further UV-VIS spectrum was recorded. Following conversion for the encapsulated amounts of active substance, with the aid of the respective calibration plot, the value obtained was then corrected by the dilution factor.

The long-term stability of the saturated active-substance solutions prepared in the manner described was, generally, very good (several weeks).

Before the actual solubilization experiments were carried out using the hyperbranched polymer of the invention, to start with, in a similar way to the procedure described above, the solubility of nimodipine and of pyrene in water was measured. A water solubility of 1.1 mg/l for nimodipine and of 0.1 mg/l for pyrene was obtained. Below, in the context of all discussions relating to the relative solubility and, alternatively, the improvement in solubility, it is these experimentally determined values which are used.

TABLE 2
Solubilization of nimodipine and pyrene in aqueous solutions (1%
by weight) of the hyperbranched polyesters (a.1) to (a.5).

| | | | Solubility of nimodipine | | Solubility of pyrene | |
|---|---|---|---|---|---|---|
| | Mₙ | | [mg/g | [mmol/mol | [mg/g | [mmol/mol |
| (a) | [g/mol] | PD | (a)] | (a)] | (a)] | (a)] |
| (a.1) | 1580 | 9.0 | 0.5 | 2 | 0.01 | 0.1 |
| (a.2) | 1470 | 3.1 | 0.1 | 1 | 0.01 | 0.1 |
| (a.3) | 1135 | 7.0 | 0.3 | 1 | 0.03 | 0.2 |
| (a.4) | 1660 | 9.8 | 0.1 | 1 | 0.12 | 1.0 |
| (a.5) | 520 | 1.8 | 0.2 | 1 | 0.01 | <0.1 |

Figures for molecular weight Mₙ and for polydispersity PD are from GPC measurements.

With the aid of the hyperbranched polymer (c.1) of the invention it was possible to solubilize 18 mg of nimodipine or 14 mg of pyrene per liter of water. Compared with the hyperbranched polyesters (a), this gives improvements in solubility by a factor of up to 4 (nimodipine) or even up to 12 (pyrene).

TABLE 3
Solubilization of nimodipine and pyrene in aqueous solutions (1%
by weight) of the hyperbranched polymer (c.1) of the invention

| | | | Solubility of nimodipine | | Solubility of pyrene | |
|---|---|---|---|---|---|---|
| | Mₙ | | [mg/g | [mmol/mol | [mg/g | [mmol/mol |
| (c) | [g/mol] | PD | (c)] | (c)] | (c)] | (c)] |
| (c.1) | 13 200 | n.d. | 1.8 | 57 | 1.4 | 91 |

Mₙ was determined by means of ¹H-NMR spectroscopy with the assistance of the results for (a.1), Table 1.

1: A process for solubilizing hydrophobic active substances in an aqueous medium, which comprises using as assistant at least one hyperbranched polymer obtainable by
(a) preparing at least one hyperbranched polyester obtainable
(a1) by polycondensing at least one dicarboxylic acid or one or more derivatives thereof with one or more at least trifunctional alcohols, or
(a2) by polycondensing at least one tricarboxylic acid or higher polycarboxylic acid or one or more derivatives thereof with one or more diols, or
(a3) by polycondensing at least one dicarboxylic acid or at least one derivative thereof with a mixture of at least one diol and at least one at least trifunctional alcohol, or
(a4) by polycondensing at least one diol with a mixture of at least one dicarboxylic acid or at least one derivative thereof and at least one tricarboxylic or tetracarboxylic acid or at least one derivative thereof,
(b) reacting the polyester with at least one isocyanate or chlorocarbonic ester which carries at least one polyalkylene oxide unit attached via a carbonate group, urea group or urethane group,
or one hyperbranched polyester (a).

2: The process according to claim 1, wherein hyperbranched polyester (a) is a polyester having an acid number in the range from 1 to 50 mg KOH/g.

3: The process according to claim 1, wherein the polyalkylene oxide unit is capped with a C₁-C₄ alkyl group.

4: The process according to claim 1, wherein hyperbranched polymer employed has a molecular weight Mₙ in the range from 500 to 50 000 g/mol.

5: The process according to claim 1, wherein hydrophobic active substances are selected from crop protection agents and pharmaceutically active substances.

6: The process according to claim 1, wherein hydrophobic active substances are selected from cardiovascular agents and cytostatics.

7: The process according to claim 1, wherein hyperbranched polymer (a) is reacted
(b1) with at least one reaction product of at least one diisocyanate with a polyalkylene glycol capped with a C₁-C₄ alkyl group.

8: The process according to claim 1, wherein at least 90 mol % of the functional groups of hyperbranched polyester (a) are reacted with isocyanate or a chlorocarbonic ester which carries at least one polyalkylene oxide unit attached via a carbonate group, urea group or urethane group.

9: A hyperbranched polymer obtainable by
(a) preparing at least one hyperbranched polyester obtainable
(a1) by polycondensing at least one dicarboxylic acid or one or more derivatives thereof with one or more at least trifunctional alcohols, or
(a2) by polycondensing at least one tricarboxylic acid or higher polycarboxylic acid or one or more derivatives thereof with one or more diols, or
(a3) by polycondensing at least one dicarboxylic acid or at least one derivative thereof with a mixture of at least one diol and at least one at least trifunctional alcohol, or
(a4) by polycondensing at least one diol with a mixture of at least one dicarboxylic acid or at least one derivative thereof and at least one tricarboxylic or tetracarboxylic acid or at least one derivative thereof,
(b) reacting the polyester with at least one isocyanate or chlorocarbonic ester which carries at least one polyalkylene oxide unit attached via a carbonate group, urea group or urethane group.

10: The hyperbranched polymer according to claim 9, wherein hyperbranched polyester (a) is a polyester having an acid number in the range from 1 to 50 mg KOH/g.

11: The hyperbranched polymer according to claim 9, wherein hyperbranched polyester (a) is reacted
(b1) with at least one reaction product of at least one diisocyanate with a polyalkylene glycol capped with a C₁-C₄ alkyl group.

12: The hyperbranched polymer according to claim 9, wherein at least 90 mol % of the functional groups of hyperbranched polyester (a) are reacted with isocyanate or a chlorocarbonic ester which carries at least one polyalkylene oxide unit attached via a carbonate group, urea group or urethane group.

13: A complex comprising at least one hyperbranched polymer according to claim 9 and at least one hydrophobic active substance.

14: An aqueous formulation comprising at least one complex according to claim 13.

15: A process for preparing a complex according to claim 13, which comprises mixing at least one hyperbranched polymer with at least one hydrophobic active substance.

16: A process for preparing a hyperbranched polymer according to claim 9 by reacting
(a) at least one hyperbranched polyester obtainable
(a1) by polycondensing at least one dicarboxylic acid or one or more derivatives thereof with one or more at least trifunctional alcohols, or
(a2) by polycondensing at least one tricarboxylic acid or higher polycarboxylic acid or one or more derivatives thereof with one or more diols,
(b) with at least one isocyanate or chlorocarbonic ester which carries at least one polyalkylene oxide unit attached via a carbonate group, urea group or urethane group.
